(19) United States
(12) Patent Application Publication
(10) Pub. No.: US 2016/0224309 A1
(43) Pub. Date: Aug. 4, 2016

(54) PORTABLE AUDIO ADAPTER WITH BULIT-IN FLASH MEMORY

(71) Applicants: PETER LEEKUO CHOU, Orange, CA (US); MARK JIM TEKUNOFF, La Habra, CA (US)

(72) Inventors: PETER LEEKUO CHOU, Orange, CA (US); MARK JIM TEKUNOFF, La Habra, CA (US)

(73) Assignee: KINGSTON TECHNOLOGY CORPORATION, Fountain Valley, CA (US)

(21) Appl. No.: 14/614,343

(22) Filed: Feb. 4, 2015

(51) Int. Cl. G06F 3/16

(52) U.S. Cl. CPC G06F 3/165; G06F 3/162

(57) ABSTRACT

A portable audio adapter device includes a built-in flash memory, an audio port, a main body, the main body including the flash memory and the audio port, a cable, the cable attached to the main body, and a USB-compliant connector, the connector attached to an end of the cable and providing connection to an audio source, wherein the built-in flash memory has a memory capacity to store user audio preference settings, and the audio port provides connection to a headphone or a loudspeaker. The portable audio adapter device has a shape of dongle. The portable audio adapter device can automatically launch user audio preferences and can operate with more than one audio sources.

### BACKGROUND OF THE INVENTION

1. Field of the Invention

The present invention relates generally to audio adapter devices and, more specifically, to a portable audio adapter device with built-in flash memory for storing user settings or preferences.

2. Discussion of the Related Art

Loudspeakers have been widely used to enhance users' audio experience. Traditionally, a loudspeaker arrangement, e.g., for a home theater, includes an audio receiver/amplifier that is connected to an audio source (for example, a radio or a television), and a set of loudspeakers. The audio receiver/amplifier generally has a user interface to allow a user to adjust sound profiles, such as volume, bass and other sound amplifications. The audio receiver/amplifier's user interface can be rotating dials or sliding bars.

Based on the user's selected settings, the audio receiver/amplifier then adjusts the audio signals and/or loudspeaker settings in an attempt to provide particular sound settings or profiles for the user. However, any user's selected setting is accessible only locally at that particular audio receiver/amplifier.

Similarly, with the development and adoption of digital audio, more audio sources, e.g., music players, televisions and computers, now include digital sound cards to provide digital audio themselves without an audio receiver/amplifier. For example, a computer can be preinstalled with a sound card and corresponding sound editor software. Therefore, through the computer user interface, e.g., a keyboard and a mouse, a computer user can select particular sound settings after running the sound editor software on the computer. Similar to the conventional audio receiver/amplifier, any user's selected setting is accessible only locally at that particular computer.

Therefore, what is needed is a device that can enable a user's audio preference to be portable. In particular, when using a headphone, which is a pair of small loudspeakers that are designed to be portable, the need to enable a user's audio preference to be portable is especially important. Currently, even though a user can use the headphone with different audio sources, the user needs to first download the sound editor software onto each audio sources and input or set up his/her sound settings through each audio source's interface to enjoy his/her preferred sound profile via the headphone from that particular audio source. Also needed is a portable audio adapter device that is compact and have few or no moving parts.

### SUMMARY OF THE INVENTION

Accordingly, embodiments of the invention are directed to a portable audio adapter device that substantially obviates one or more of the problems due to limitations and disadvantages of the related art.

An object of embodiments of the invention is to provide a portable audio adapter device that includes a built-in flash memory for storing user settings or preferences.

Another object of embodiments of the invention is to provide a portable audio adapter device that automatically downloads any headphone driver software and preloads user settings or preferences.

Another object of embodiments of the invention is to provide an audio adapter device that enables user headphone settings or preferences to be portable.

Another object of embodiments of the invention is to provide a compact audio adapter device that enables user headphone settings or preferences to be portable.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a device includes a built-in flash memory, an audio port, a main body, the main body including the flash memory and the audio port, a cable, the cable attached to the main body, and a USB-compliant connector, the connector attached to an end of the cable and providing connection to an audio source, wherein the built-in flash memory has a memory capacity to store user audio preference settings, and the audio port provides connection to a headphone or a loudspeaker.

In another aspect, a portable device includes a flash memory, a first audio port, a second audio port, a main body, the main body including the flash memory, the first audio port and a second audio port, a cable, the cable attached to the main body, and a USB-compliant connector, the connector attached to an end of the cable and providing connection to an audio source, wherein the built-in flash memory has a memory capacity to store user audio preference settings, and at least one of the first and second audio ports.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1A is an illustration of an on-ear/over-ear headphone according to the related art.

FIG. 1B is a flow chart illustrating the steps of setting up a headphone according to the related art.

FIG. 2A is an illustration of a portable audio adapter device according to an embodiment of the present invention.

FIG. 2B is an illustration of an audio portion of a portable audio adapter device according to an embodiment of the present invention.

FIG. 2C is an illustration of components of a portable audio adapter device according to an embodiment of the present invention.

FIG. 3 is a flow chart illustrating the steps of setting up a portable audio adapter according to an embodiment of the present invention.

FIG. 4 is an illustration of contents held in a portable audio adapter device according to an embodiment of the present invention.

### DETAILED DESCRIPTION OF THE PREFERRED EMBODIMENTS

Reference will now he made in detail to the preferred embodiments of the invention, examples of which are illustrated in the accompanying drawings.

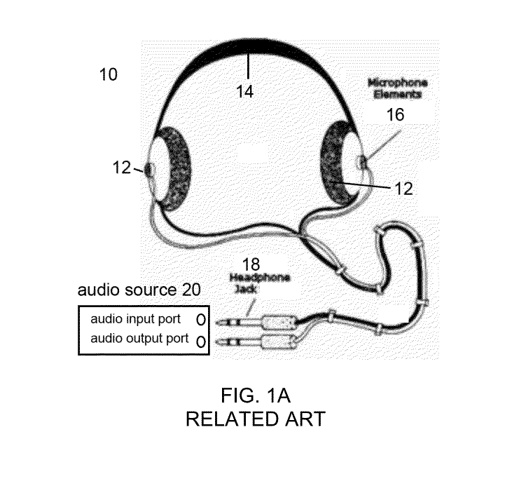

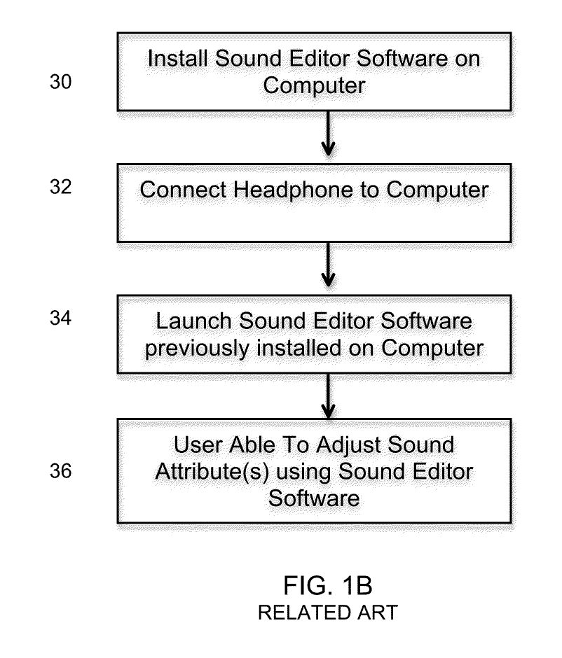

FIG. 1A is an illustration of an on-ear/over-ear headphone with microphone according to the related art. As illustrated in FIG. 1A, a headphone 10 includes a pair of ear-cups 12, a headband 14, microphone elements 16 and cable. The ear-cups 12 are connected at two ends of the headband 14. The headband 14 is intended to be over a user's head during use, while the ear-cups 12 are intended to be on or over the user's ears. In addition, the microphone elements 16 are mounted on one or both of the ear-cups 12 to provide microphone features. To use, the headphone 10 is connected to an audio source 20 via the cable. In particular, the cable includes one or more jacks 18, which are to be plugged into ports on the audio source 20. For example, one of the jacks 18 is plugged into an audio output port on the audio source 20 for receiving audio signals from the audio source 20 to the ear-cups 12. Another of the jacks 18 is plugged into an audio input port on the audio source 20 for transmitting audio signals from the ear-cups 12 to the audio source 20.

FIG. 1B is a flow chart illustrating the steps of setting up a headphone according to the related art. As illustrated in FIG. 113, to enable a user to adjust sound profile when using a computer, the user needs to install a sound editor software on a computer as illustrated at step 30. Subsequently, the user connects a headphone to the computer at step 32. At step 34, the user launches the sound editor software that was previously installed at step 30 on the computer. Then, through the computer's user interface, such as a mouse pointer, the user can adjust sound profile/attributes using the sound editor software.

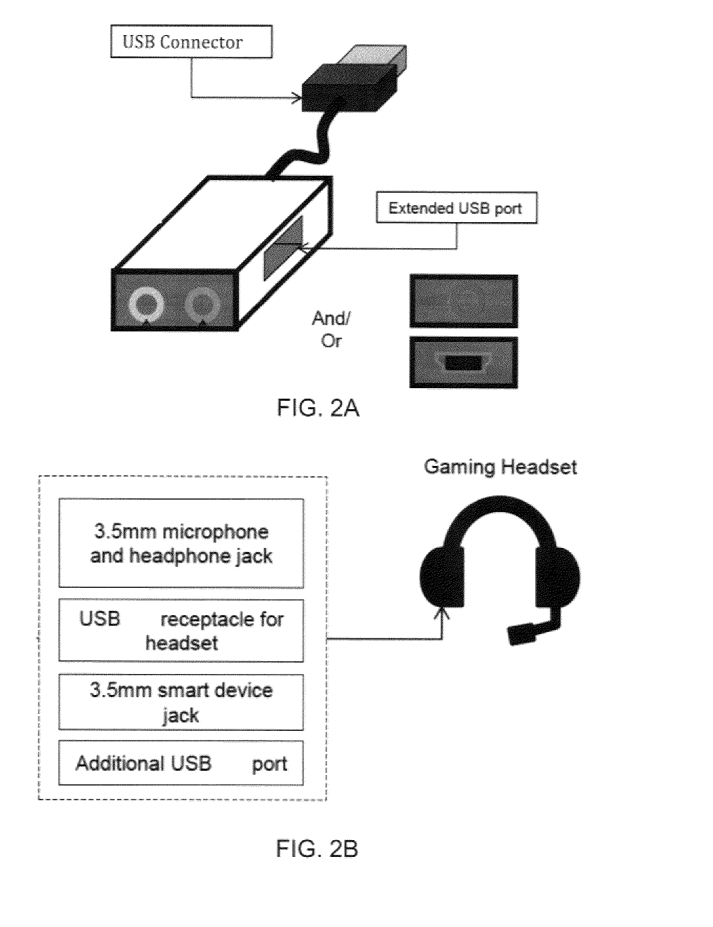

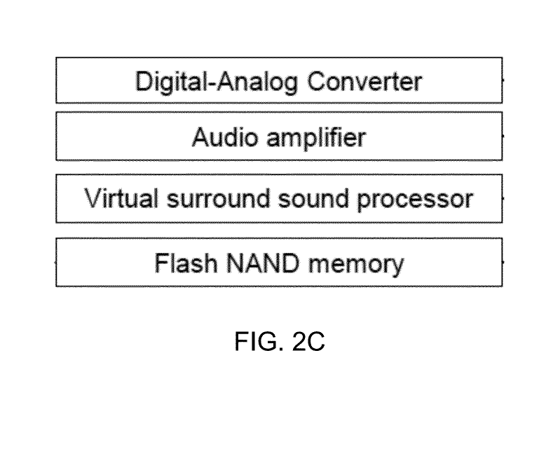

FIG. 2A is an illustration of a portable audio adapter device according to an embodiment of the present invention. In FIG. 2A, a portable audio adapter device 100 can operate with a headphone or a loudspeaker. The portable audio adapter device 100 includes a main body 110, a cable 112 and a connector 114. The main body 110 includes at least one audio port 116 for receiving an audio connector from a headphone, a loudspeaker or a sound bar.

The cable 112 is attached to the main body 110. For example, the cable 112 may be attached to the main body 110 on a side or at a portion of the main body 110 opposite or different from the audio port 116. The connector 114 is at an end of the cable 112. The connector 114 provides a connection to an audio source. In particular, the connector 114 may be a connector in compliance with a USB Specification. Alternatively, the connector 114 may be a connector in compliance with High-Definition Multimedia Interface (HDMI). For example, the connector 114 can support connection with a digital audio source, such as a computer, a game console or digital television.

In addition to the audio port 116, the main body 110 may further include additional ports 118a and 118b. The ports 118a and 118b may include an alternative or secondary audio port or a USB port. The additional ports 118a and 118b provides expansions from or additional access to the audio adapter device 100. Alternatively or in addition, the additional ports 118a and 118 provides additional access to the audio source and/or the headphone/loudspeaker/sound bar that is connected to the audio adapter device 110.

The main body 110 preferably is small, compact and lightweight. For example, the main body 110 may have a size similar to a USB flash drive. The main body 110 preferably may weight about 9.0 gram or 0.02 pound, and the dimensions of the main body 110 preferably may be about 50 mm×20 mm×8 mm. Alternatively, the main body 110 may weight up to 227 gram or 0.50 pound. The dimensions of the main body 110 may be 50˜130 mm in length, 20˜82 mm in width, and 8˜52 mm in height.

Further, the main body 110 preferably includes no moving parts. For example, the portable audio adapter device 100 preferably is a small dongle or a dongle-like device that can be readily transported.

FIG. 2B is an illustration of an audio portion of a portable audio adapter device according to an embodiment of the present invention. As illustrated in FIG. 2B, when using with a headphone, the audio port 116 can support, for example, a stereo jack plug (in styles: tip ring (TR), tip ring sleeve (IRS), tip ring ring sleeve (TRRS), a mini stereo jack plug, 3.5 mm audio jack, 3.5 mm smart device jack, or another version), a XLR connector, a MIDI connector, a USB connector, or stereo RCA plugs.

FIG. 2C is an illustration of components of a portable audio adapter device according to an embodiment of the present invention. As illustrated in FIG. 2B, the main body 110 (shown in FIG. 2A) is built-in with various components. The main body 110 includes an audio amplifier 120, a sound processor 122, and a memory 124. The sound processor 122 can manage the audio amplifier 120, and may be a virtual surround sound processor. In particular, together with the audio amplifier 120, the sound processor 122 provides additional or alternative sound amplification to the audio source or the headphone/loudspeaker/sound bar.

The memory 124 has sufficient memory capacity to store a sound editor software and user preferences, and may be a flash NAND memory. Thus, during operation, the sound processor 122 or another built-in processor can launch the sound editor software stored in the memory 124.

In addition, the main body 110 may include a digital-analog converter 126 to support an analog signal. Thus, during operation, the sound processor 122 or another built-in processor can convert analog signals to digital signals and/or digital signals to analog signal using the digital-analog converter 126.

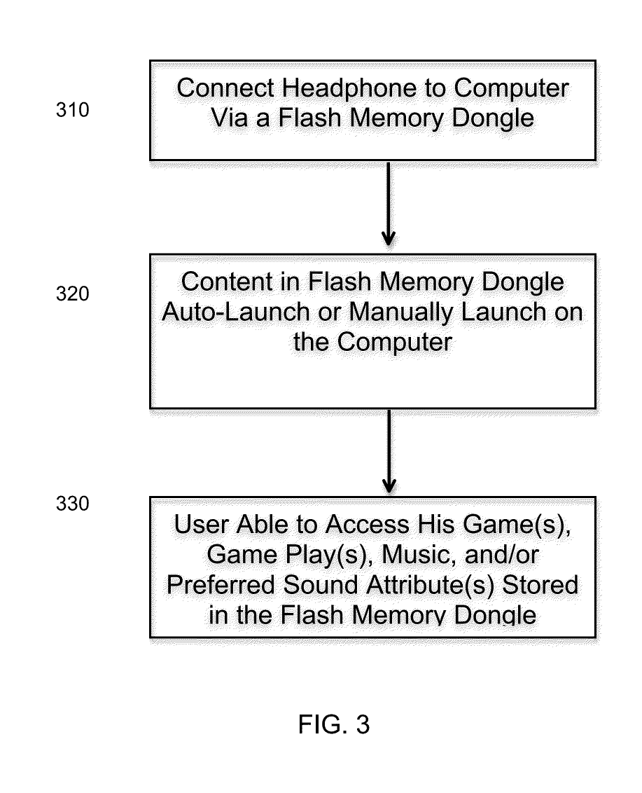

FIG. 3 is a flow chart illustrating the steps of setting up a portable audio adapter according to an embodiment of the present invention. As illustrated in FIG. 3, a portable audio adapter according to an embodiment of the present invention operates as a flash memory dongle. At step 310, the flash memory dongle is to be connected between a headphone to a computer. At step 320, the content stored in the flash memory in the flash memory dongle can be automatically launched or manually launched onto the computer. The content may include sound editor software, user audio preferences, user songs, or user save game. Then, at step 330, the user is able to access his game, game plays, or music on that computer. Similarly, the user is able to enjoy audio at his preferred sound attributes on that computer view the connected headphone. Therefore, the steps of downloading or installing sound editor software, for example, from a CD, are skipped. Although not shown, instead of a headphone, the flash memory dongle can be used with or connected to a loudspeaker or a sound bar.

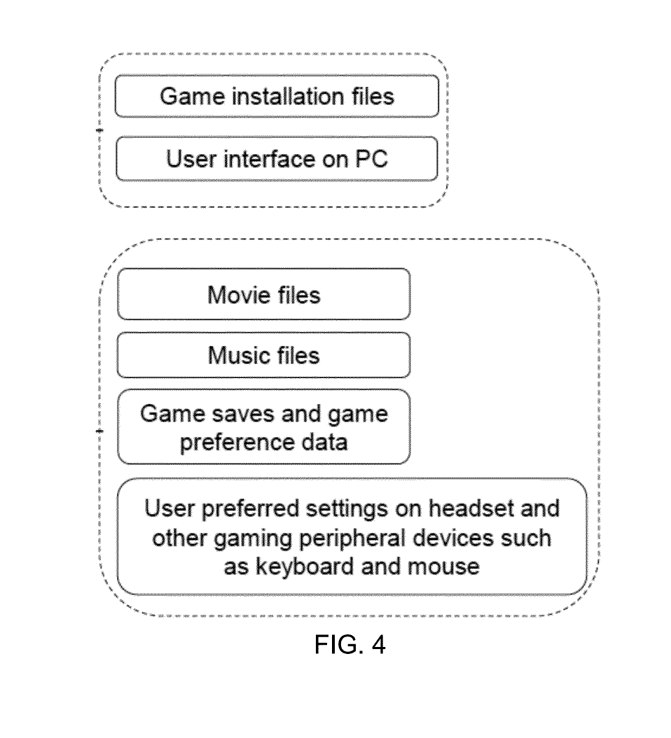

FIG. 4 is an illustration of contents held in a portable audio adapter device according to an embodiment of the present invention. As illustrated in FIG. 4, the memory 124 (shown in FIG. 2A) stores various content and has sufficient memory capacity to store installation file(s). In particular, for enabling game plays to a user, the memory 124 stores game installation file(s). In addition or alternatively, the memory 124 stores user interface installation files(s). For example, a user may prefer specialty gaming interfaces or peripheral devices that require installations. The installation file(s) for the user interface or the peripheral device can be stored in the memory 124.

As illustrated in FIG. 4, the memory 124 also stores preferred headphone settings. Although not shown, instead of a headphone setting, the memory 124 can store preferred settings for a loudspeaker or a sound bar. In addition, due to the substantial storage capacity in the memory 124, the memory 124 stores and supports a set of preferred user audio preferences for connecting with more than one audio sources. For example, the portable audio adapter can detect and/or determine the type of audio source it is connected to and adjust the audio settings stored in the memory 124 according to the detected audio source type, in order to achieve the same set of preferred user audio preferences even after the adapter is disconnected from a first audio source and is reconnected to a second or different audio source. Alternatively, the memory 124 stores and support different sets of preferred user audio preferences for connecting to different audio sources, respectively. Further, the memory 124 stores and support different sets of preferred user audio preferences for different users.

In addition with gaming, game saves and/or game preference data can be saved and stored in the memory 124. In addition, movie files and music files can be stored in the memory 124.

It will be apparent to those skilled in the art that various modifications and variations can be made in the audio adapter device of embodiments of the invention without departing from the spirit or scope of the invention. Thus, it is intended that embodiments of the invention cover the modifications and variations of this invention provided they come within the scope of the appended claims and their equivalents.

What is claimed:

1. A portable device, comprising:
a built-in flash memory;
an audio port;
a main body, the main body including the flash memory and the audio port;
a cable, the cable attached to the main body; and
a USB-compliant connector, the connector attached to an end of the cable and providing,
wherein the built-in flash memory has a memory capacity to store user audio preference settings, and the audio port provides connection to a headphone or a loudspeaker.

2. The device according to claim 1, wherein the device has a shape of dongle.

3. The device according to claim 1, wherein the audio source includes one of a computer, a game console or digital television.

4. The device according to claim 1, further comprising a sound processor and audio amplifier.

5. The device according to claim 1, wherein the memory capacity of the built-in flash memory stores an installation file for the headphone or the loudspeaker.

6. The device according to claim 1, wherein the memory capacity of the built-in flash memory stores game saves or gaming preference data.

7. The device according to claim 1, wherein the memory capacity of the built-in flash memory stores one of movie or music files.

8. The device according to claim 1, wherein the device automatically launches or retrieves the stored user audio preferences after establishing the connection to the audio source.

9. The device according to claim 1, wherein the device launches or retrieves the stored user audio preferences when operating with more than one audio sources.

10. A portable device, comprising:
a flash memory;
a first audio port;
a second audio port;
a main body, the main body including the flash memory, the first audio port and a second audio port;
a cable, the cable attached to the main body; and
a USB-compliant connector, the connector attached to an end of the cable and providing connection to an audio source,
wherein the built-in flash memory has a memory capacity to store user audio preference settings, and at least one of the first and second audio ports provides connection to a headphone or a loudspeaker.

11. The device according to claim 10, wherein the device launches or retrieves different user audio preferences when operating with different audio source.

12. The device according to claim 10, wherein the device has a shape of dongle.

13. The device according to claim 10, wherein the audio source includes one of a computer, a game console or digital television.

14. The device according to claim 10, further comprising a sound processor and audio amplifier.

15. The device according to claim 10, further comprising a digital-analog converter.

16. The device according to claim 10, wherein the memory capacity of the flash memory stores an installation file for the headphone or the loudspeaker.

17. The device according to claim 10, wherein the memory capacity of the built-in flash memory stores game saves or gaming preference data.

18. The device according to claim 10, wherein the memory capacity of the built-in flash memory stores one of movie or music files.

19. The device according to claim 10, wherein the device automatically launches or retrieves the stored user audio preferences after establishing the connection to the audio source.

20. The device according to claim 10, wherein the device launches or retrieves the stored user audio preferences when operating with more than one audio sources.
